(19) United States
(12) Patent Application Publication
(10) Pub. No.: US 2014/0087834 A1
(43) Pub. Date: Mar. 27, 2014

(54) EVENT GAME MACHINE FOR BUSINESS USE

(71) Applicant: Myung Ho HA, Seoul (KR)

(72) Inventor: Myung Ho HA, Seoul (KR)

(21) Appl. No.: 14/025,433

(22) Filed: Sep. 12, 2013

(30) Foreign Application Priority Data
Sep. 25, 2012 (KR) 10-2012-0106478

(51) Int. Cl. G07F 17/34

(52) U.S. Cl. CPC G07F 17/34
USPC 463/20

(57) ABSTRACT

The present invention relates to event game machine for businesses wherein it is composed of event starting unit that turns the machine on when activating object is inserted; event controlling unit which activates the game algorithm as event starting unit is activated in order to determine whether same menu or products are shown; output unit wherein it displays winning result on the screen when more than set number of same menu or products are shown or sending the information to the registered information processing device such as the business owner's computer. When the coupon or the winning ticket is provided as the result of game algorithm set into motion by activating objects such as medal, coin, coupon, and ticket or saved up points, it can entertain the customers and also provide them with free drinks or food which helps promote the business.

### CROSS-REFERENCE(S) TO RELATED APPLICATION

This application claims priority of Korean Patent Application No. 10-2012-0106478, filed on Sep. 25, 2012, in the Korean Intellectual Property Office, the contents of which are incorporated herein by reference.

### BACKGROUND OF THE INVENTION

1. Field of the Invention

The present invention relates to an event game machine for business use, and more particularly, to an event game machine for business use, in which upon input of the predetermined operation object means capable of operating the event game machine (for example, a medal (or coin), a coupon, a ticket, a reserved point (or a medium storing a reserved point), or a bead, a predetermined game algorithm is executed, and when the same menu (or product) slots come out more than a set number, a coupon (or a printed matter or a ticket containing a winning report), so that a customer can be provided with alcoholic beverages or appetizers free of charge and relieve boredom while being waiting, and sale promotion of menus (or products) can be caused in views of a business owner.

2. Description of the Related Art

Recently, with the improvement of living environment and the development of eating-out culture, many persons have used restaurants such as pub or a bar so as to eat out or associate other persons. There has been a need for an apparatus that relieves boredom or gives a gift through a game by enabling a customer of a restaurant such as a pub or a bar to enjoy a game while the customer is waiting after giving an order or is drinking.

For example, there is a method in which an owner of a store (for example, a pub) provides a customer with an instant lottery and gives the customer a predetermined gift (for example, alcoholic beverages or appetizers) when the customer wins the provided instant lottery.

However, such a prior art may cause an inclination to gambling. Since a game machine is not used, there is a limitation in arousing a customer's interest. Also, it is not easy to cause sale promotion.

### SUMMARY OF THE INVENTION

The present invention has been made in an effort to solve the above problems and is directed to provide an event game machine for business use, which can provide a customer with alcoholic beverages or appetizers, relieve boredom while the customer is waiting, and cause sale promotion of menus (or products) in views of a business owner.

In order to achieve the above object, an event game machine for business, which can promote sales, according to the present invention, includes: an event starting unit configured to start an operation of the event game machine when operation object means capable of operating the event game machine is input; an event controlling unit configured to execute a set game algorithm according to an event start operation of the event starting unit and determine whether same menu (or product) slots (for example, slots corresponding to 500 cc) come out more than a set number (for example, four); and an event winning notifying unit configured to display an event winning fact or transmit the event winning fact to a registered information processing device (for example, a terminal (PC) of an owner of a relevant store) when the same menu (or product) slots come out more than the set number.

Preferably, the event game machine further includes an outputting unit configured to output a set coupon (or a printed matter or a predetermined set ticket containing a winning report) usable at a relevant store under the control of the event controlling unit when the event controlling unit determines that the same menu (or product) slots come out more than the preset number.

The game event machine further includes a game machine driving controlling unit configured to control an operation of the event game machine according to whether a predetermined pinball arrives at a set valid area or a set invalid area when the pinball is hit. For example, when the predetermined pinball arrives at the set valid area, the operation of the event game machine is permitted, and when the predetermined pinball arrives at the set invalid area, the operation of the event game machine is stopped.

Preferably, the operation object means capable of operating the event game machine is one of a predetermined medal (or coin), a coupon, a ticket, a reserved point (or a medium storing a reserved point) usable at a general store, and a bead.

The event game machine further includes: a key configured to output an effect sound; and a controller configured to perform control such that a set winning effect sound is output when the key is pressed after an event winning fact is notified.

### BRIEF DESCRIPTION OF THE DRAWINGS

FIG. 1 is a diagram illustrating an event game machine for business use according to the present invention.

FIG. 2 is a block diagram illustrating an internal configuration of the event game machine for business use according to the present invention.

FIG. 3 is a flowchart illustrating sequential operations of the event game machine for business use according to the present invention.

FIG. 4 is an exemplary user interface (UI) diagram illustrating a menu (or product) slot according to the present invention.

### DETAILED DESCRIPTION OF EXEMPLARY EMBODIMENTS

Hereinafter, embodiments of the present invention will be described below with reference to the accompanying drawings.

The embodiments set forth herein are merely for describing the present invention so that those skilled in the art can easily carry out the present invention. The scope of the present invention is not limited to these embodiments.

In order to clearly describe the present invention, parts having no relation to the description are omitted, and like reference numerals are assigned to like elements throughout the specification.

Unless explicitly described to the contrary, the terms “comprise,” “include,” “have,” etc., will be understood to imply the inclusion of stated elements but not the exclusion of any other elements.

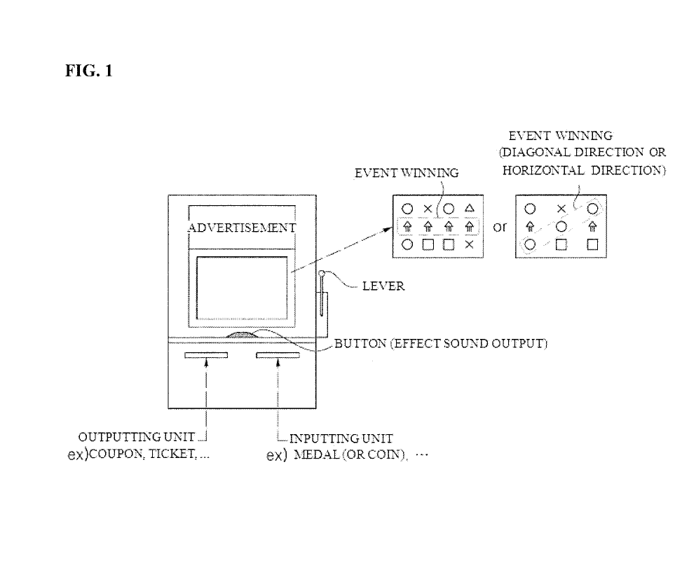

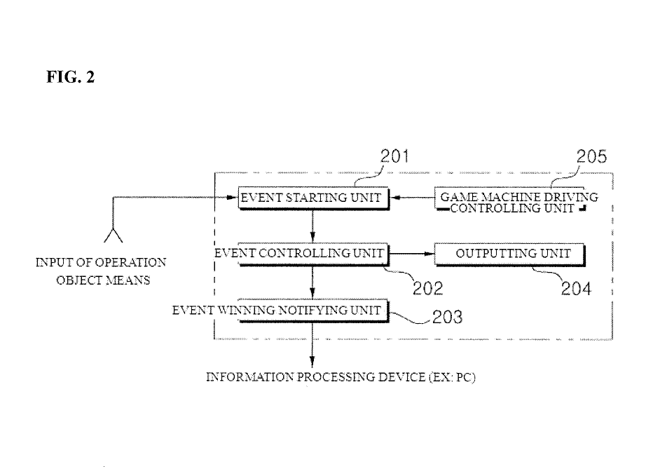

FIG. 1 is a diagram illustrating an event game machine for business use according to the present invention, and FIG. 2 is a block diagram illustrating an internal configuration of the event game machine for business use according to the present invention.

As illustrated in FIG. 2, the event game machine for business use according to the present invention includes an event starting unit 201, an event controlling unit 202, and an event winning notifying unit 203. The event game machine further includes an outputting unit 204 and a game machine driving controlling unit 205.

Upon input of predetermined operation object means capable of operating the even game machine through a lever (for example, a medal (or coin), a coupon, a ticket, a reserved point (or a medium storing a reserved point) usable in a general store, or a bead), the event starting unit 201 generates a predetermined start signal for starting the operation of the event game machine, and inputs the start signal to the event controlling unit 202. The operation object means (for example, a medal (or coin), or the like) may be provided from an owner of a relevant store. In a case where the reserved point is input, when the input reserved point (or the medium storing the reserved point) is more than a set point, the operation of the event game machine may be started. For reference, a button of FIG. 1 is an input unit configured to generate a predetermined effect sound when a customer knowing that he/she has won the event through a screen presses the button. In this case, the event game machine may further include a controller configured to control an output of a set event winning effect sound when the button is pressed.

When the event operation is started according to the event start operation of the event starting unit 201, the event controlling unit 202 executes a set game algorithm, determines whether the same menu (or product) slots (for example, slots corresponding to 500 cc) come out more than a set number (for example, four), and notifies the determination result to the event winning notifying unit 203. For example, in the case of a pub which sells alcoholic beverages, when four or more slots corresponding to 500 cc come out, the event winning fact is notified to the event winning notifying unit. The menu (or product) slot may be different according to the menu or product the corresponding store sells. For example, in the case of a pub, the slot may be a slot representing alcoholic beverages or various appetizers (for example, dried squid). The slot display user interface (UI) may be implemented in a 3×4 or 3×3 form. In the case of the 3×3 form, it may be determined that the customer wins the event when the same slots come out in a diagonal direction as well as in a horizontal direction. In the case of the 3×4 form, it may be determined that the customer wins the event when the same slots come out in a horizontal direction.

As the determination result of the event controlling unit 202, when the same menu (or product) slots come out more than a preset number, the event winning notifying unit 203 notifies the event winning fact to the customer by displaying it on the screen, or notifies the event winning fact to the owner of the store by transmitting it to a registered information processing device (for example, a terminal (PC) of an owner of a relevant store).

As the determination result of the event controlling unit 202, when the same menu (or product) slots come out more than a preset number, the outputting unit 204 outputs a set coupon (or a printed matter or a predetermined set ticket containing a winning report) usable at a corresponding store under the control of the event controlling unit 202. The customer receives a benefit of the event winning (or a bonus (for example, appetizers or alcoholic beverages)) through the output set coupon (or a printed matter or a predetermined set ticket containing a wining report).

The game machine driving controlling unit 205 controls the operation of the event game machine according to whether a predetermined pinball hit by a customer in a pinball game arrives at a set valid area or a set invalid area. For example, when the predetermined pinball arrives at the set valid area, the operation of the event game machine is permitted, and when the predetermined pinball arrives at the set invalid area, the operation of the event game machine is stopped.

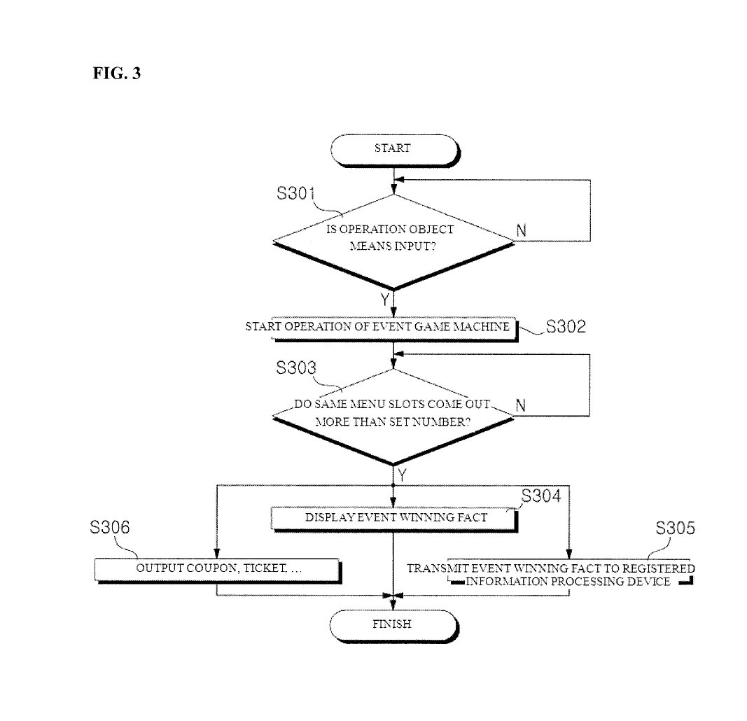

Hereinafter, the operation of the event game machine for business use according to the present invention, as illustrated in FIGS. 1 and 2, will be described with reference to FIG. 3.

FIG. 3 is a flowchart illustrating sequential operations of the event game machine for business use according to the present invention.

As illustrated in FIG. 3, the event starting unit receives the predetermined operation object means capable of operating the event game machine (S301).

Then, upon input of the operation object means, a predetermined start signal for starting the operation of the corresponding event game machine is generated and input to the event controlling unit (S302).

The operation object means may be a medal (or coin), a coupon, a ticket, a reserved point (or a medium storing a reserved point) usable in a general store, or a bead.

The operation object means (for example, a medal (or coin), or the like) may be provided from an owner of a relevant store.

In a case where the reserved point is input, when the input reserved point (or the medium storing the reserved point) is more than a set point, the operation of the event game machine may be started.

When the event operation is started according to the event start operation of the event starting unit, the event controlling unit executes a set game algorithm, and determines whether the same menu (or product) slots (for example, slots corresponding to 500 cc) come out more than a set number (for example, four) (S303).

Then, the determination result is notified to the event winning notifying unit.

For example, in the case of a pub which sells alcoholic beverages, when four or more slots corresponding to 500 cc come out, the event winning fact is notified to the event winning notifying unit.

The menu (or product) slot may be differently determined according to the menu or product the corresponding store sells. For example, in the case of a pub, the slot may be a slot representing alcoholic beverages or various appetizers (for example, dried squid).

Next, as the determination result of the event controlling unit, when the same menu (or product) slots come out more than a preset number, the event winning notifying unit notifies the event winning fact to the customer by displaying it on the screen (S304), or notifies the event winning fact to the owner of the store by transmitting it to a registered information processing device (for example, a terminal (PC) of an owner of a relevant store) (S305).

On the other hand, as the determination result of the event controlling unit, when the same menu (or product) slots come out more than a preset number, the outputting unit outputs a set coupon (or a printed matter or a predetermined set ticket containing a winning report) usable at a corresponding store under the control of the event controlling unit (S306).

The customer receives a benefit of the event wining (or a bonus (for example, appetizers or alcoholic beverages)) through the output set coupon (or a printed matter or a predetermined set ticket containing a wining report).

The game machine driving controlling unit may control the operation of the event game machine according to whether a predetermined pinball hit by a customer in a pinball game arrives at a set valid area or a set invalid area.

For example, when the predetermined pinball arrives at the set valid area, the operation of the event game machine is permitted, and when the predetermined pinball arrives at the set invalid area, the operation of the event game machine is stopped.

As described above, upon input of the predetermined operation object means capable of operating the even game machine (for example, a medal (or coin), a coupon, a ticket, or a reserved point (or a medium storing a reserved point)), a predetermined game algorithm is executed, and when the same menu (or product) slots come out more than a set number, a coupon (or a printed matter or a ticket containing a winning report). Therefore, the customer can be provided with alcoholic beverages or appetizers free of charge, and sale promotion of menus (or products) can be caused in views of the business owner.

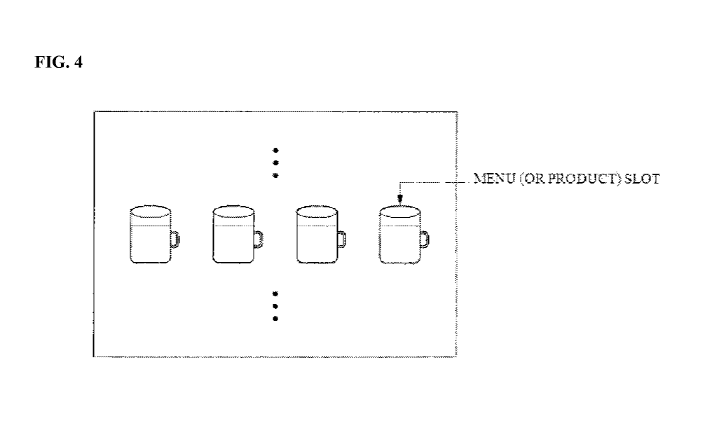

FIG. 4 is a diagram exemplarily illustrating the menu (or product) slots according to the present invention.

As illustrated in FIG. 4, the customer wins the event when the same menu (or product) slots come out more than a preset number, and a coupon or a ticket is provided to the corresponding customer. For example, in the case of a pub which sells alcoholic beverages, when four or more slots corresponding to 500 cc come out, a coupon or a ticket is provided to the corresponding customer, and the customer can be provided with alcoholic beverages or appetizers free of charge. The menu (or product) slot may be different according to the menu or product the corresponding store sells. For example, in the case of a pub, the slot may be a slot representing alcoholic beverages or various appetizers (for example, dried squid).

According to the present invention, upon input of the predetermined operation object means capable of operating the even game machine (for example, a medal (or coin), a coupon, a ticket, a reserved point (or a medium storing a reserved point), or a bead), a predetermined game algorithm is executed, and when the same menu (or product) slots come out more than a set number, a coupon (or a printed matter or a ticket containing a winning report) is output. Therefore, the customer can be provided with alcoholic beverages or appetizers free of charge, and sale promotion of menus (or products) can be caused in views of the business owner.

While the invention has been shown and described with reference to certain exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

### REFERENCE SIGNS LIST

201: event starting unit

22: event controlling unit

203: event winning notifying unit

204: outputting unit

205: game machine driving controlling unit

What is claimed is:

1. An event game machine for business use, comprising:
an event starting unit configured to start an operation of the event game machine when operation object means capable of operating the event game machine is input;
an event controlling unit configured to execute a set game algorithm according to an event start operation of the event starting unit and determine whether same menu (or product) slots come out more than a set number;
an event winning notifying unit configured to display an event winning fact or transmit the event winning fact to a registered information processing device when the same menu (or product) slots come out more than the set number;
an outputting unit configured to output a set coupon (or a printed matter or a predetermined set ticket containing a winning report) under the control of the event controlling unit when the event controlling unit determines that the same menu (or product) slots come out more than the preset number; and
a game machine driving controlling unit configured to control an operation of the event game machine according to a predetermined pinball arrives at a set valid area or a set invalid area when the pinball is hit.

2. The event game machine of claim 1, wherein the operation object means capable of operating the event game machine is one of a medal (or coin), a coupon, a ticket, a reserved point (or a medium storing a reserved point), and a bead.

3. The event game machine of claim 1, further comprising:
a key configured to output an effect sound; and
a controller configured to perform control such that a set winning effect sound is output when the key is pressed after an event winning fact is notified.
